(19) United States
(12) Patent Application Publication
(10) Pub. No.: US 2008/0317355 A1
(43) Pub. Date: Dec. 25, 2008

(54) Method and apparatus for determining characteristics of an object from a contour image

(75) Inventors: Yun Luo, Livonia, MI (US); David Parent, South Lyon, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive U.S. LLC

(21) Appl. No.: 11/820,814

(22) Filed: Jun. 21, 2007

(51) Int. Cl. G06K 9/48; B60R 21/01; G06K 9/62

(52) U.S. Cl. 382/199; 382/224; 701/45

(57) ABSTRACT

Systems and methods are provided for determining an associated occupant class for a vehicle occupant from an image of a vehicle interior. An image characterizer (154) determines a centroid of the image of the vehicle occupant is determined and produces an image representative signal that represents the image data as a series of discrete values according to its position relative to the determined centroid. A frequency domain transform (156) converts the image representative signal to a frequency domain to produce a plurality of coefficients. A pattern recognition classifier (56) determines an associated output class for the occupant utilizing at least two of the plurality of coefficients. A controller interface (58) regulates an actuatable occupant restraint device according to the determined output class.

### TECHNICAL FIELD

The present invention is directed generally to machine vision systems and is particularly directed to a method and apparatus for determining characteristics of an occupant from a contour image. The present invention is particularly useful in occupant restraint systems for occupant classification and tracking.

### BACKGROUND OF THE INVENTION

Actuatable occupant restraining systems having an inflatable air bag in vehicles are known in the art. Such systems that are controlled in response to whether the seat is occupied, an object on the seat is animate or inanimate, a rearward facing child seat present on the seat, and/or in response to the occupant's position, weight, size, etc., are referred to as smart restraining systems. One example of a smart actuatable restraining system is disclosed in U.S. Pat. No. 5,330,226.

Pattern recognition systems can be loosely defined as systems capable of distinguishing between classes of real world stimuli according to a plurality of distinguishing characteristics, or features, associated with the classes. Many smart actuatable restraint systems rely on pattern recognition systems to identify the nature of the occupant of a vehicle seat. For example, if it is determined that a seat is empty, it is advantageous to refrain from actuating a protective device. In addition, the classification can provide knowledge of certain characteristics of the occupant that are helpful in tracking the occupant's movements in the vehicle. Such tracking can further increase the effectiveness of the actuatable restraint system.

In a smart actuatable restraint system, a stereo camera arrangement can be utilized to obtain a depth image of the vehicle interior. The use of a stereo camera arrangement can provide additional characteristics of the occupant that are not available from a two-dimensional image. In addition, the use of a depth image would make it easier to separate the background of the image from the occupant. It will be appreciated, however, that this requires at least an additional camera and considerable additional processing. Since an actuatable restraining system must adjust in real time for occupant characteristics, this additional processing must also be performed, making the cost of obtaining a depth image significant for some applications.

### SUMMARY OF THE INVENTION

In accordance with one aspect of the present invention, a method is provided for classifying an image of a vehicle occupant into one of a plurality of output classes to regulate the operation of a vehicle occupant protection system. A centroid of the image of the vehicle occupant is determined. An image representative signal is produced that represents the image data as a series of discrete values according to its position relative to the determined centroid. The image representative signal is converted to a frequency domain to produce a plurality of coefficients. An associated output class for the occupant is determined utilizing at least two of the plurality of coefficients. An actuatable occupant restraint device is regulated according to the determined output class.

In accordance with another aspect of the invention, a system is provided for determining an associated occupant class for a vehicle occupant from an image of a vehicle interior. An image generator isolates a portion of the image that represents the vehicle occupant and determines a contour of the occupant from the isolated portion of the image of the vehicle interior. A centroid locator determines a centroid of the image contour. A contour characterizer produces a image representative signal that represents the distance between the centroid and the contour along each of a plurality of angles. A frequency domain transform converts the image representative signal to a frequency domain to produce a plurality of frequency coefficients. A coefficient selector selects a subset of the plurality of frequency coefficients as the plurality of feature values. A pattern recognition classifier determines an associated output class for the occupant utilizing the selected subset of parameters.

In accordance with yet another aspect of the present invention, a computer readable medium is provided comprising executable instructions that, when executed by a data processing system, generate a plurality of feature values representing a vehicle occupant from an image contour taken from an image of the vehicle interior. The executable instructions include a centroid location routine that determines a centroid of the image portion. An image characterizing routine transforms image data within the image portion to a polar coordinate representation having an origin at the determined centroid. A plurality of samples are taken from the transformed image data to provide the image representative signal. A frequency domain transform converts the image representative signal to a frequency domain to produce a plurality of frequency coefficients. A coefficient selection routine selects a subset of the plurality of frequency coefficients as the plurality of feature values.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a schematic illustration of an actuatable restraining system in accordance with an exemplary embodiment of the present invention;

FIG. 2 illustrates an exemplary image classification system for classifying a vehicle occupant in accordance with the present invention;

FIG. 3 illustrates an exemplary image generation system for use in an image classification system in accordance with an aspect of the present invention;

FIG. 4 illustrates an exemplary feature extraction system for use in an image classification system in accordance with an aspect of the present invention;

FIG. 5 illustrates a methodology for classifying a vehicle occupant into one of a plurality of output classes in accordance with an aspect of the present invention;

FIG. 6 illustrates a second exemplary methodology 240 for producing an image representative signal from a portion of an image representing a vehicle occupant;

FIG. 7 illustrates an exemplary image portion and a representation of the exemplary image portion after a polar transformation; and

FIG. 8 illustrates a computer system that can be employed to implement systems and methods described herein, such as based on computer executable instructions running on the computer system.

### DESCRIPTION OF PREFERRED EMBODIMENT

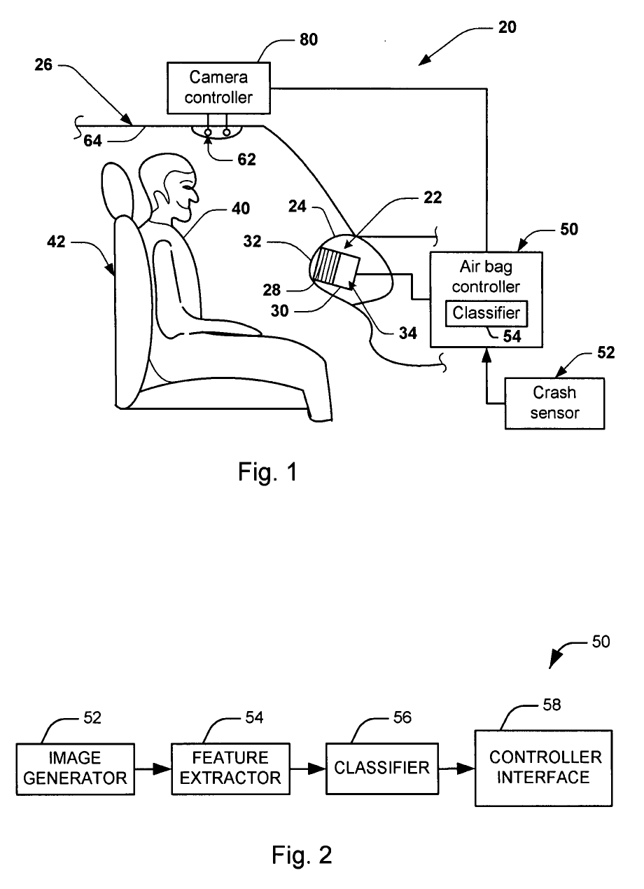

Referring to FIG. 1, an actuatable occupant restraint system 20, in accordance with an exemplary embodiment of the present invention, includes an air bag assembly 22 mounted in an opening of a dashboard or instrument panel 24 of a vehicle 26. The air bag assembly 22 includes an air bag 28 folded and stored within the interior of an air bag housing 30. A cover 32 covers the stored air bag and is adapted to open easily upon inflation of the air bag 28.

The air bag assembly 22 further includes a gas control portion 34 that is operatively coupled to the air bag 28. The gas control portion 34 may include a plurality of gas sources (not shown) and vent valves (not shown) for, when individually controlled, controlling the air bag inflation, (e.g., timing, gas flow, bag profile as a function of time, gas pressure, etc.). Once inflated, the air bag 28 may help protect an occupant 40, such as a vehicle passenger, sitting on a vehicle seat 42. Although the embodiment of FIG. 1 is described with regard to a vehicle passenger seat, it is applicable to a vehicle driver seat and back seats and their associated actuatable restraining systems. The present invention is also applicable to the control of side actuatable restraining devices and to actuatable devices deployable in response to rollover events.

An air bag controller 50 is operatively connected to the air bag assembly 22 to control the gas control portion 34 and, in turn, inflation of the air bag 28. The air bag controller 50 can take any of several forms such as a microcomputer, discrete circuitry, an application-specific-integrated-circuit (“ASIC”), etc. The controller 50 is further connected to a vehicle crash sensor 52, such as one or more vehicle crash accelerometers. The controller monitors the output signal(s) from the crash sensor 52 and, in accordance with an air bag control algorithm using a deployment control algorithm, determines if a deployment event is occurring (i.e., an event for which it may be desirable to deploy the air bag 28). There are several known deployment control algorithms responsive to deployment event signal(s) that may be used as part of the present invention. Once the controller 50 determines that a deployment event is occurring using a selected crash analysis algorithm, for example, and if certain other occupant characteristic conditions are satisfied, the controller 50 controls inflation of the air bag 28 using the gas control portion 34, (e.g., timing, gas flow rate, gas pressure, bag profile as a function of time, etc.).

The air bag restraining system 20, in accordance with the present invention, further includes a camera 62, preferably mounted to the headliner 64 of the vehicle 26, connected to a camera controller 80. The camera controller 80 can take any of several forms such as a microcomputer, discrete circuitry, ASIC, etc. The camera controller 80 is connected to the air bag controller 50 and provides a signal to the air bag controller 50 to provide data relating to various image characteristics of the occupant seating area, which can range from an empty seat, an object on the seat, a human occupant, etc. Herein, image data of the seating area is generally referred to as occupant data, which includes all animate and inanimate objects that might occupy the occupant seating area. The air bag control algorithm associated with the controller 50 can be made sensitive to the provided image data. For example, if the provided image data indicates that the occupant 40 is an object, such as a shopping bag, and not a human being, actuating the air bag during a crash event serves no purpose. Accordingly, the air bag controller 50 can include a pattern recognition classifier assembly 54 operative to distinguish between a plurality of occupant classes based on the image data provided by the camera controller 80 that can then, in turn, be used to control the air bag.

FIG. 2 illustrates an exemplary image classification system 90 for classifying a vehicle occupant in accordance with the present invention. It will be appreciated, that for the purposes of explanation, the term “vehicle occupant” is used broadly to include any individual or object that may be positioned on a vehicle seat. Appropriate occupant classes can represent, for example, children, adults, various child and infant seats, common objects, and an empty seat class, as well as subdivisions of these classes (e.g., a class for adults exceeding the ninetieth percentile in height or weight). It will be appreciated that the system can be implemented, at least in part, as a software program operating on a general purpose processor. Therefore, the structures described herein may be considered to refer to individual modules and tasks with a software program. Alternatively, the system 90 can be implemented as dedicated hardware or as some combination of hardware and software.

The image classification system 90 includes an image generator 92 that receives an image of a vehicle interior and prepares the image for feature extraction. In accordance with an aspect of the present invention, the image generator 92 can be operative to locate a blob of pixels representing a vehicle occupant from the image and, in one implementation, prepare a contour image of the blob. In one implementation, the image generator 92 can also utilize one or more preprocessing techniques to enhance the image, eliminate obvious noise, and facilitate contour detection prior to locating the occupant.

The generated pixel blob is then sent to a feature extractor 94. Feature extraction converts the contour into a vector of numerical measurements, referred to as feature variables. Thus, the feature vector represents the pixel blob, and thus the occupant, in a compact form. The vector is formed from a sequence of measurements performed on the contour. In accordance with an aspect of the present invention, the features are selected such that the measured features are invariant to scale, translation, and rotation of the image. Put simply, the feature vector produced for a given image should be the same for a scaled version of the image, an image in which the blob of pixels represented by the contour has been repositioned within the image, and a rotated version of the image.

The extracted feature vector is then provided to a pattern recognition classifier 96. The pattern recognition classifier 96 relates the feature vector to a most likely output class from a plurality of output classes, and determines a confidence value that the vehicle occupant is a member of the selected class. This can be accomplished by any appropriate classification technique, including statistical classifiers, neural network classifier, support vector machines, Gaussian mixture models, and K-nearest neighbor algorithms. The selected output class is then provided, through a controller interface 98, to a controller for an actuatable occupant restraint device, where it is used to regulate operation of an actuatable occupant restraint device associated with the vehicle occupant.

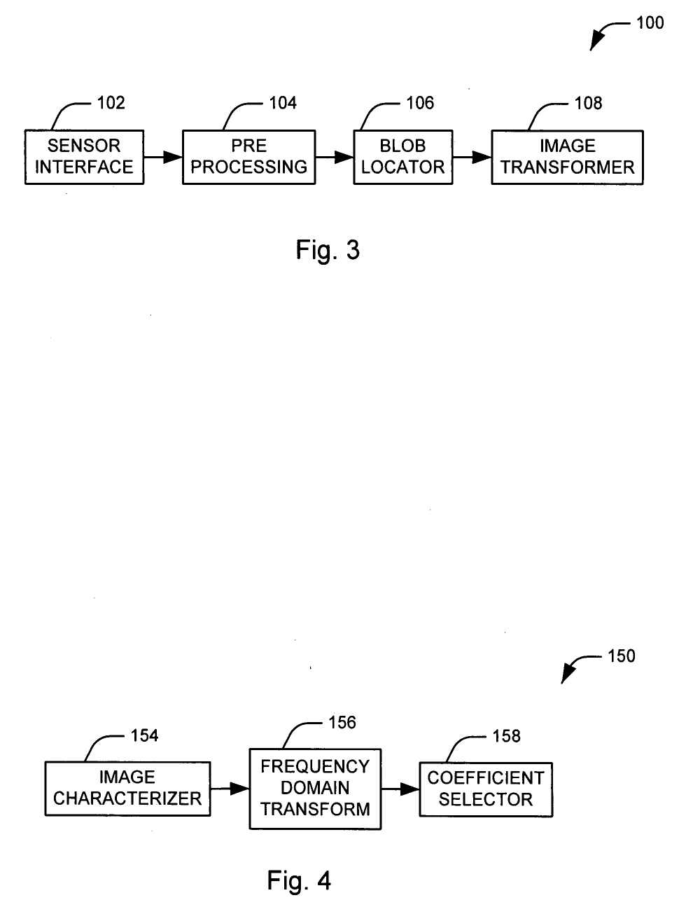

FIG. 3 illustrates an exemplary image generation system 100 for use in an image classification system in accordance with an aspect of the present invention. The image generation system includes a sensor interface 102 that operates in conjunction with at least one sensor located within the vehicle to obtain images of a region of interest within the vehicle. For example, the at least one sensor can include one or more cameras that are configured within the vehicle interior to obtain an image of a vehicle seat and its associated occupant. In the illustrated example, an overhead camera in the headliner of the vehicle seat is utilized to obtain an overhead view of a front or rear passenger seat. The obtained image can then be provided to a preprocessing component 104 that can utilize various image processing techniques to increase the associated dynamic range of the images and to remove static background elements.

The preprocessed image can then be passed to a blob locator 106 that identifies a portion of the image that represents the vehicle occupant. In one implementation, the blob locator 106 utilizes a thresholding routine to identify the image foreground and background and binarizes the image to separate the foreground from the remainder of the image. The remaining pixels can then be grouped via an appropriate clustering algorithm, such that groups of spatially proximate pixels are grouped into connected “blobs” of pixels. A bounding window can then be applied to the image to exclude blobs that are outside a region of interest associated with the vehicle seat. The largest blob within the region of interest can be assumed to represent the vehicle occupant. The blob locator 106 can also determine an associated centroid of the blob. This can be accomplished by any of several available center of mass algorithms for finding the centroid of a two-dimensional object.

The located blob is then provided to an image transformation component 110 that produces a transformed image from the blob image from which translation, rotation, and scale invariant features can be extracted. In one implementation, a polar transform of the image is produced, with the centroid utilized as the origin of the associated polar coordinates. In another implementation, the image transformation component defines a contour from the blob image representing a layer of outermost pixels within the blob. It will be appreciated that by using only the image largest blob and, specifically, the contour of the blob, the image extraction can be made position invariant, as features are extracted from the largest blob image is utilized regardless of its position within the region of interest defined by the bounding window.

FIG. 4 illustrates an exemplary feature extraction system 150 for use in an image classification system in accordance with an aspect of the present invention. The system 150 receives a transformed image representing a vehicle occupant from an associated image generation system. An image characterizer 154 makes a plurality of mathematical measurements of the image to produce a series of values representing the contour. For example, one or more values (e.g., intensity, text, or saturation values) can be sampled from predetermined locations on the transformed image to produce an image representative signal. Alternatively, the image characterizer 154 can determine a distance between the determined centroid and the contour along each of a plurality of angles to produce an image representative signal. In one implementation, the image representative signal can be simplified by binning (e.g., combining) the determined distances within each interval of two degrees of arc around the contour to produce a feature vector having one hundred eighty elements.

The image representative signal is provided to a frequency domain transform 156 that transforms the image representative signal into the frequency domain as a series of frequency coefficients representing respective frequency components of the signal. For example, the frequency domain transform 156 can utilize a Discrete Fourier Transform to produce a frequency domain representation of the image representative signal as a series of Fourier coefficients. By transforming the image representative signal into the frequency domain, the signal becomes invariant to rotation, as the same frequency components are present regardless of the orientation of the contour. In accordance with an aspect of the present invention, the various frequency coefficients can be normalized using the zeroth order coefficient (e.g., the coefficient representing the DC component) to produce a set of coefficients that are also invariant to scale.

The frequency domain representation of the image representative signal is then provided to a coefficient selector 158. The coefficient selector 158 selects a subset of the plurality of frequency coefficients to produce a set of features describing the occupant contour. For example, a set number of highest order coefficients can be selected, as to select the coefficients representing the frequency components having the greatest contribution to the image representative signal. The coefficients can be provided to a pattern recognition classifier to determine an appropriate occupant class from the selected coefficients.

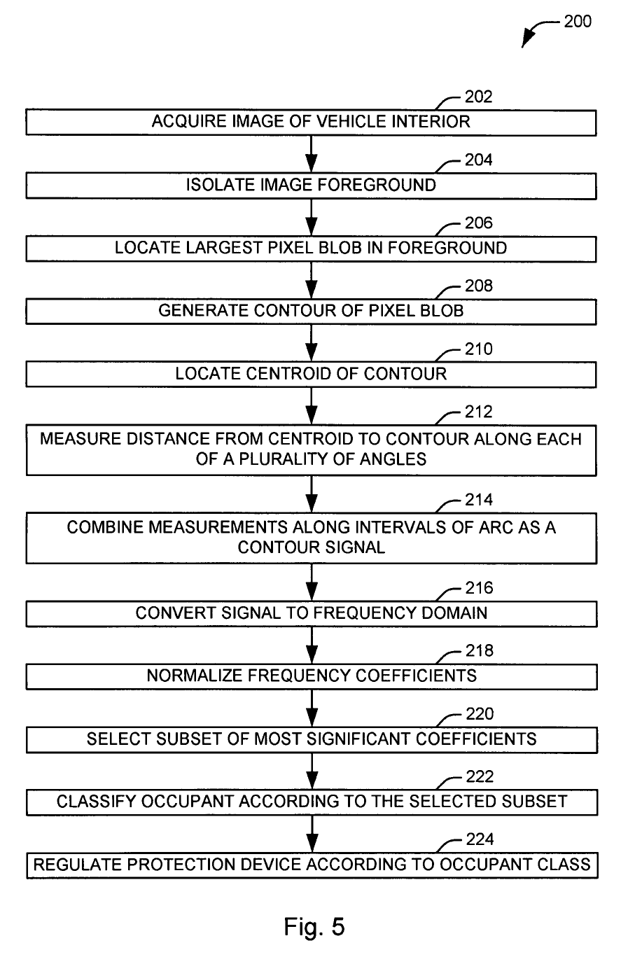

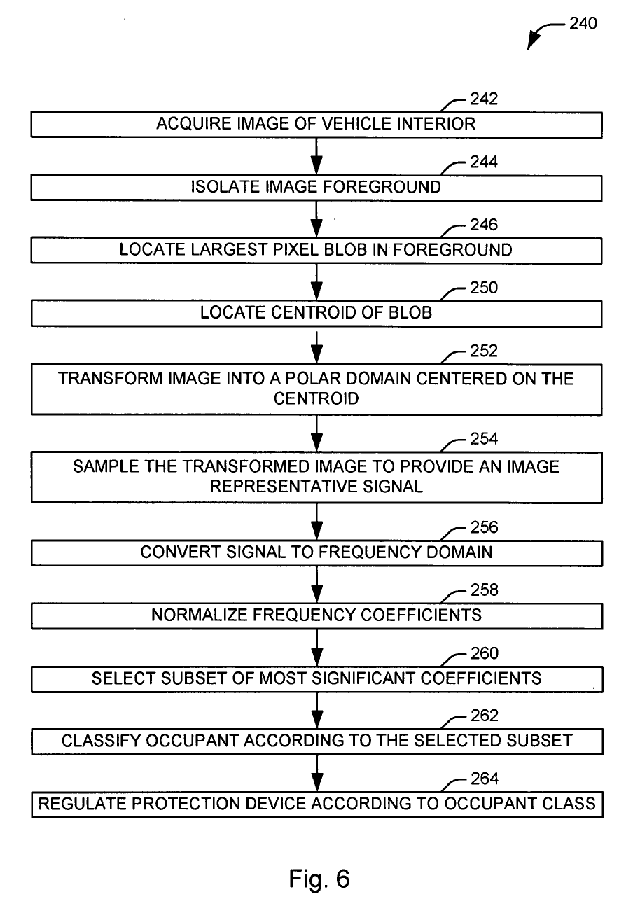

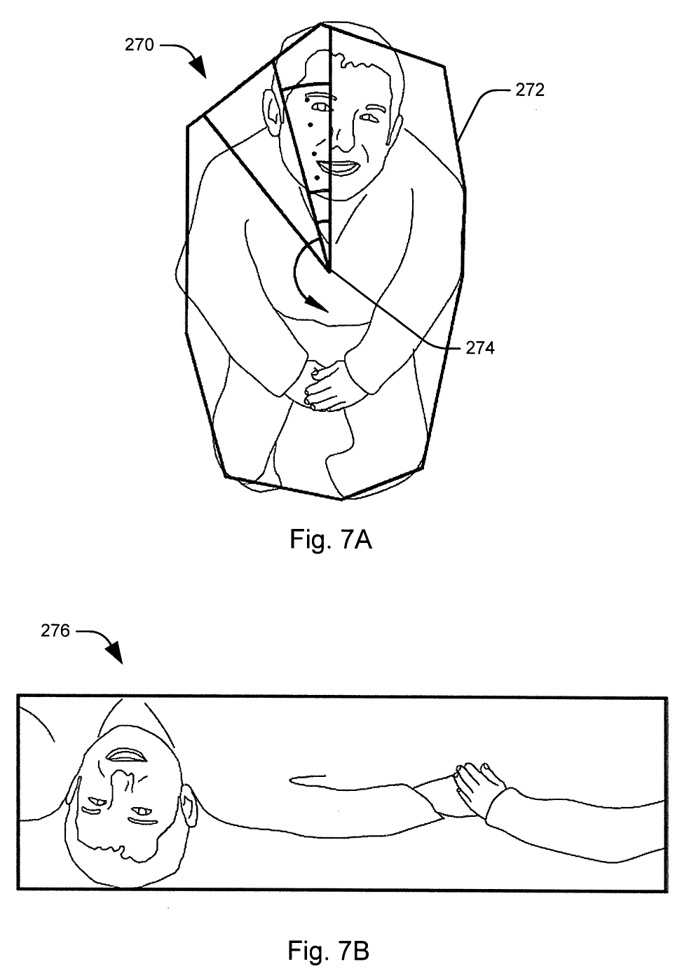

In view of the foregoing structural and functional features described above, methodologies in accordance with various aspects of the present invention will be better appreciated with reference to FIGS. 5 and 6. While, for purposes of simplicity of explanation, the methodologies of FIGS. 5 and 6 are shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention.

FIG. 5 illustrates a methodology 200 for classifying a vehicle occupant into one of a plurality of output classes in accordance with an aspect of the present invention. At step 202, an image is obtained of a region of interest within the vehicle. For example, an overhead camera in the headliner of the vehicle seat is utilized to obtain an overhead view of a front or rear passenger seat. At step 204, the foreground of the image is isolated from the image background. For example, a thresholding routine can be used to identify the image foreground and background and the image can be binaried to separate the foreground from the remainder of the image.

At step 206, a largest pixel window within a region of interest can be selected. To this end, the remaining pixels can be grouped via a clustering algorithm, and a bounding window, representing the region of interest, can then be applied to the image to exclude blobs that are not positioned in a desired region of the vehicle seat. The largest blob within the region of interest is selected as representing the vehicle occupant. At step 208, a contour is defined from the blob image to represent the vehicle occupant at step 210, an associated centroid of the blob is determined. At step 212, the distance between the determined centroid and the contour is determined along each of a plurality of angles. At step 214, the measured distances can be combined along predetermined intervals of arc to produce a image representative signal.

At step 216, the image representative signal is converted to a frequency domain, with the signal represented by a series of frequency coefficients. For example, a Discrete Fourier Transform can be used to produce a frequency domain representation of the image representative signal. At step 218, the various frequency components can be normalized to produce a set of coefficients that are also invariant to the scale of the image. At step 220, a subset of the plurality of frequency coefficients is selected, for example, a set number of the highest order coefficients can be selected, such that the frequency components having the most significant contribution to the image representative signal are selected.

At step 222, an appropriate occupant class for the occupant is determined from the selected coefficients. For example, a pattern recognition classifier can be used to select an appropriate class from the selected coefficients. In one implementation, the possible output classes can include classes representing adults, children, rearward facing child seats, frontward facing infant seats, empty seats, and other objects. At step 224, the operation of the actuatable occupant restraint device can be regulated according to the selected class. For example, where the restraint device is an airbag, the airbag may be fired only when the occupant is an adult or a child, and the force of deployment of the airbag can be altered when the occupant is a child.

FIG. 6 illustrates a second exemplary methodology 240 for producing an image representative signal from a portion of an image representing a vehicle occupant. At step 242, an image is obtained of a region of interest within the vehicle. For example, an overhead camera in the headliner of the vehicle seat is utilized to obtain an overhead view of a front or rear passenger seat. At step 244, the foreground of the image is isolated from the image background. For example, a thresholding routine can be used to identify the image foreground and background and the image can be binaried to separate the foreground from the remainder of the image.

At step 246, a largest pixel window within a region of interest can be selected. To this end, the remaining pixels can be grouped via a clustering algorithm, and a bounding window, representing the region of interest, can then be applied to the image to exclude blobs that are not positioned in a desired region of the vehicle seat. The largest blob within the region of interest is selected as representing the vehicle occupant. At step 250, a centroid of the image portion is determined.

At step 252, the image data within the blob is subjected to a polar transformation using the determined centroid as the origin in the polar coordinate system represented by the transform. FIG. 7, which illustrates an exemplary image portion 270, defined by a contour 272 having a centroid 274, and the transformed image 276. The transformed data is then sampled at a plurality of representative positions to produce an image representative signal at 254. The sampled values comprising the signal can include the intensity, texture or any appearance-based features at various locations within the polar transformed image 276. In an exemplary implementation, the polar transformed image 276 is sampled in a rectangular grid, effectively sampling the image in along the radial and angular axes. Accordingly, the image representative signal can be conceptualized as a two-dimensional array of samples, representing the radial and angular dimensions of the polar coordinate system represented by the polar transform.

At step 256, the image representative signal is converted to a frequency domain, with the signal represented by a series of frequency coefficients. For example, a Discrete Cosine Transform can be applied to the sampled values in the radial direction and a Discrete Fourier Transform can be applied in the angular direction to produce a two dimensional set of frequency domain coefficients. The Discrete Cosine Transform has the effect of compressing the most useful information from the image into the lower order frequency coefficients, and the Discrete Fourier Transform ensures that the frequency domain representation of the image will be effectively rotationally invariant. The result of the two transforms is a two-dimensional coefficient image, such as the image illustrated at 278 in FIG. 7.

At step 258, the various frequency components can be normalized to produce a set of coefficients that are also invariant to the scale of the image. At step 260, a subset of the plurality of frequency coefficients is selected, for example, a set number of the highest order coefficients can be selected, such that the frequency components having the most significant contribution to the image representative signal are selected. For example, the lowest order coefficients can be selected.

At step 262, an appropriate occupant class for the occupant is determined from the selected coefficients. For example, a pattern recognition classifier can be used to select an appropriate class from the selected coefficients. In one implementation, the possible output classes can include classes representing adults, children, rearward facing child seats, frontward facing infant seats, empty seats, and other objects. At step 264, the operation of the actuatable occupant restraint device can be regulated according to the selected class. For example, where the restraint device is an airbag, the airbag may be fired only when the occupant is an adult or a child, and the force of deployment of the airbag can be altered when the occupant is a child.

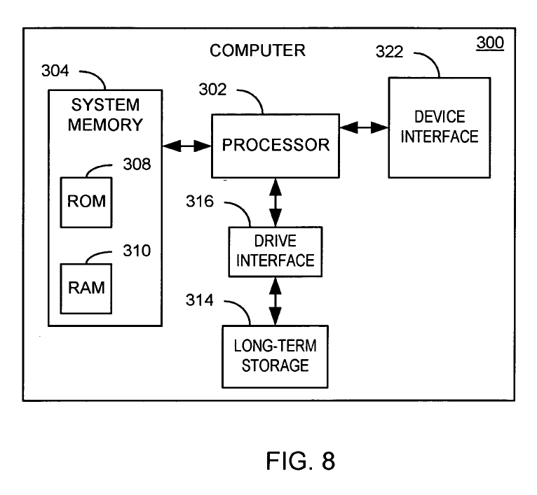

FIG. 8 illustrates a computer system 300 that can be employed as part of a vehicle occupant protection device controller to implement systems and methods described herein, such as based on computer executable instructions running on the computer system. The computer system 300 can be implemented on one or more general purpose networked computer systems, embedded computer systems, routers, switches, server devices, client devices, various intermediate devices/nodes and/or stand alone computer systems. Additionally, the computer system 300 can be implemented as part of the computer-aided engineering (CAE) tool running computer executable instructions to perform a method as described herein.

The computer system 300 includes a processor 302 and a system memory 304. Dual microprocessors and other multi-processor architectures can also be utilized as the processor 302. The processor 302 and system memory 304 can be coupled by any of several types of bus structures, including a memory bus or memory controller, a peripheral bus, and a local bus using any of a variety of bus architectures. The system memory 304 includes read only memory (ROM) 308 and random access memory (RAM) 310. A basic input/output system (BIOS) can reside in the ROM 308, generally containing the basic routines that help to transfer information between elements within the computer system 300, such as a reset or power-up.

The computer system 300 can include one or more types of long-term data storage 314, including a hard disk drive, a magnetic disk drive, (e.g., to read from or write to a removable disk), and an optical disk drive, (e.g., for reading a CD-ROM or DVD disk or to read from or write to other optical media). The long-term data storage can be connected to the processor 302 by a drive interface 316. The long-term storage components 314 provide nonvolatile storage of data, data structures, and computer-executable instructions for the computer system 300. A number of program modules may also be stored in one or more of the drives as well as in the RAM 310, including an operating system, one or more application programs, other program modules, and program data. Other vehicle systems can communicate with the computer system via a device interface 322. For example, one or more devices and sensors can be connected to the system bus 306 by one or more of a parallel port, a serial port or a universal serial bus (USB).

From the above description of the invention, those skilled in the art will perceive improvements, changes, and modifications. Such improvements, changes, and modifications within the skill of the art are intended to be covered by the appended claims.

Having described the invention, the following is claimed:

1. A method for classifying an image of a vehicle occupant into one of a plurality of output classes to regulate the operation of a vehicle occupant protection system, comprising:
determining a centroid of the image of the vehicle occupant;
producing an image representative signal that represents the image data as a series of discrete values according to its position relative to the determined centroid;
converting the image representative signal to a frequency domain to produce a plurality of coefficients;
determining an associated output class for the occupant utilizing at least two of the plurality of coefficients; and
regulating an actuatable occupant restraint device according to the determined output class.

2. The method of claim 1, wherein producing at least one image representative signal comprises determining a distance between the centroid and the contour along each of a plurality of angles and combining the determined distances over predetermined intervals of arc to produce the image representative signal.

3. The method of claim 1, wherein converting the image representative signal to a frequency domain comprises determining a plurality of frequency coefficients representing frequency components of the image representative signal and normalizing the plurality of frequency coefficients according to a zeroth order frequency coefficient such that the coefficient values are invariant across changes in the scale of the image.

4. The method of claim 1, further comprising:
acquiring an image of a vehicle interior; and
isolating a portion of the image that represents the vehicle occupant, such that the contour of the occupant is determined from the isolated portion of the image.

5. The method of claim 4, wherein isolating a portion of the image comprises thresholding the image to identify an image foreground and binarizing the image to isolate the foreground region as a plurality of binarized pixels.

6. The method of claim 5, wherein isolating a portion of the image comprises clustering the plurality of binarized pixels into at least one pixel blob and selecting a largest pixel blob within a region of interest.

7. The method of claim 1, wherein producing a image representative signal comprises:
transforming image data within the contour to a polar coordinate representation having an origin at the determined centroid; and
taking a plurality of samples from the transformed image data to provide the image representative data.

8. The method of claim 7, wherein converting the image representative signal to a frequency domain comprises:
applying a discrete cosine transform to the image representative signal along a radial direction; and
applying a discrete Fourier transform along the angular direction.

9. A system for determining an associated occupant class for a vehicle occupant from an image of a vehicle interior comprising:
an image generator that isolates a portion of the image that represents the vehicle occupant and determines a contour of the occupant from the isolated portion of the image of the vehicle interior;
a centroid locator that determines a centroid of the image contour;
a image characterizer that produces an image representative signal that represents the distance between the centroid and the contour along each of a plurality of angles;
a frequency domain transform that converts the contour signal to a frequency domain to produce a plurality of frequency coefficients;
a coefficient selector that selects a subset of the plurality of frequency coefficients as the plurality of feature values; and
a pattern recognition classifier that determines an associated output class for the occupant utilizing the selected subset of parameters.

10. The system of claim 9, wherein the image generator isolates the portion of the image representing the vehicle occupant by thresholding the image to identify an image foreground, binarizing the image to isolate the foreground region comprising a plurality of binarized pixels, clustering the plurality of binarized pixels into at least one pixel blob, and selecting a largest pixel blob within a region of interest.

11. The system of claim 9, wherein the image characterizer determines a distance between the centroid and the contour along each of a plurality of angles and combines the determined distances over predetermined intervals of arc to produce the contour signal.

12. The system of claim 9, further comprising a sensor mounted in the headliner of the vehicle interior that produces an overhead image of one of a front passenger seat and a rear passenger seat.

13. A vehicle occupant protection system, comprising:
an actuatable vehicle occupant restraint device; and
a controller for the actuatable vehicle restraint device, comprising the system of claim 9, the actuation of the actuatable vehicle occupant restraint device being regulated by the controller in response to the determined output class.

14. A computer readable medium comprising executable instructions that, when executed by a data processing system, generate a plurality of feature values representing a vehicle occupant from an image portion taken from an image of the vehicle interior, the executable instructions comprising:
a centroid location routine that determines a centroid of the image portion;
an image characterizing routine that transforms image data within the image portion to a polar coordinate representation having an origin at the determined centroid;
taking a plurality of samples from the transformed image data to provide the image representative signal;
a frequency domain transform that converts the image representative signal to a frequency domain to produce a plurality of frequency coefficients; and
a coefficient selection routine that selects a subset of the plurality of frequency coefficients as the plurality of feature values.

15. The computer readable medium of claim 14, wherein converting the image representative signal to a frequency domain comprises:
applying a discrete cosine transform to the image representative signal along a radial direction; and
applying a discrete Fourier transform along the angular direction.

16. The computer readable medium of claim 14, the executable instructions further comprising a pattern recognition classifier that determines an associated occupant class for the vehicle occupant from a plurality of associated occupant classes.

17. The computer readable medium of claim 14, the executable instructions further comprising an image generation routine that isolates a portion of the image representing the vehicle occupant, determines a contour of the object of interest, and provides the determined contour to the centroid location routine.

18. The computer readable medium of claim 17, wherein the image generation routine isolates the portion of the image representing the vehicle occupant by thresholding the image to identify an image foreground, binarizing the image to isolate the foreground region comprising a plurality of binarized pixels, clustering the plurality of binarized pixels into at least one pixel blob, and selecting a largest pixel blob within a region of interest.

19. The computer readable medium of claim 14, wherein the frequency domain transform normalizes the plurality of frequency coefficients according to a zeroth order frequency coefficient.

20. A vehicle occupant protection system, comprising:
an actuatable vehicle occupant restraint device; and
a controller for the actuatable vehicle restraint device, comprising:
a processor that is operative to execute the executable instructions associated with the computer readable medium of claim 14.
